(19) United States
(12) Patent Application Publication
(10) Pub. No.: US 2022/0337103 A1
(43) Pub. Date: Oct. 20, 2022

(54) STATOR

(71) Applicant: ebm-papst Mulfingen GmbH & Co. KG, Mulfingen (DE)

(72) Inventors: Michael STURM, Bad Mergentheim (DE); Werner MÜLLER, Mulfingen (DE)

(21) Appl. No.: 17/720,834

(22) Filed: Apr. 14, 2022

(30) Foreign Application Priority Data
Apr. 16, 2021 (DE) 10 2021 109 652.9

(51) Int. Cl. H02K 1/16; H02K 9/00; H02K 15/02; H02K 15/085; H02K 3/48

(52) U.S. Cl. CPC H02K 1/16; H02K 9/00; H02K 15/024; H02K 15/085; H02K 3/48

(57) ABSTRACT

Stator for an electric motor, comprising the following components: at least one first basic stator, wherein the basic stator is formed from at least two basic stator modules which in an annular manner are disposed in series, wherein the first basic stator module conjointly with the at least second basic stator module forms a stator yoke, wherein each of the basic stator modules configures a stator tooth that extends radially from the stator yoke; at least one tooth shoe, wherein the tooth shoe is connected to the stator tooth in a force-fitting and/or form-fitting manner by means of a tongue-and-groove connection, in particular by means of a dovetail joint; at least one electric winding; at least one insulation which electrically isolates the basic stator from the winding, at least one expansion means; as well as at least one cooling device, wherein the components are able to be combined in a modular manner.

### CROSS-REFERENCE TO RELATED APPLICATION

This application claims the benefit of German Application No. 10 2021 109 652.9, filed Apr. 16, 2021, the contents of which is hereby incorporated by reference in its entirety, further the entirety of the attached translation of German Application No. 10 2021 109 652.9 is incorporated by reference.

### FIELD OF THE DISCLOSURE

The present disclosure relates to a stator for an electric motor.

### BRIEF SUMMARY

A stator for an electric motor includes at least one first basic stator, wherein the at least one first basic stator is formed from at least two basic stator modules which in an annular manner are disposed in series, wherein the first basic stator module conjointly with the at least second basic stator module forms a stator yoke, and wherein each of the basic stator modules configures a stator tooth that extends radially from the stator yoke. The stator includes at least one tooth shoe, wherein the at least one tooth shoe is connected to the stator tooth in a force-fitting and/or form-fitting manner by a tongue-and-groove connection. The stator includes at least one electric winding, at least one insulation which electrically isolates the at least one first basic stator from the at least one electric winding, and at least one expansion means, wherein the at least one first basic stator, the at least one tooth shoe, the at least one electric winding, and the at least one expansion means are able to be combined with one another in a modular manner.

### BRIEF DESCRIPTION OF THE DRAWINGS

FIG. 1 shows a perspective exploded view of a stator for an internal rotor electric motor;

FIG. 2 shows a perspective exploded view of a wound basic stator module for an internal rotor electric motor;

FIG. 3 shows a perspective exploded view of a stator for an external rotor electric motor;

FIG. 4 shows a perspective exploded view of two basic stators in a pre-assembly state, having an interconnection ring for an external rotor electric motor, preferably during direct winding of the basic stator;

FIG. 5 shows a perspective view of a basic stator in a pre-assembly state, having a cooling device; and

FIG. 6 shows a detailed view of a winding member 18 having a winding 9 and an interconnection region 25 for receiving a winding wire start 26 and a winding wire end 27.

### DETAILED DESCRIPTION

In the case of stators of this type, the basic concept lies in assembling the stator in a modular manner from a plurality of individual and short basic stators so as to form a basic stator group of a desired construction length. Upon being separately overmoulded with a plastics material that serves as an insulation, the individual basic stators by means of connection means integrated in the basic stators are axially assembled in series at the end sides. In this way, overmoulded layers that are significantly thinner can be generated so that thinner layer thicknesses, or insulation thicknesses, respectively, can be achieved in a stator assembled in this way in comparison to a single stator of identical construction length.

It is disadvantageous here that the teeth of the stator, in the case of a stator for an internal rotor electric motor, have to be shrunk into a housing in order for the high mechanical strength required to be achieved, this requiring additional material costs and further operating steps.

In the case of stators for external rotor electric motors, the mechanical strength has to be produced by a special design in terms of the construction of the stator yoke. A bush of the stator for an external rotor electric motor has to be specially configured in order to absorb the forces of the motor, this in some instances being implemented by means of a press-fit between the bush and the stator. However, the press-fit has the effect of expanding modular stator teeth, this resulting in minute gaps which impede the magnetic flux as well as compromise the behaviour in terms of vibrations and noise.

It is, therefore, an object of the present disclosure to overcome the aforementioned disadvantages and to provide a stator with great dimensional stability which has a minimized behaviour in terms of vibrations and noise in association with a high groove filling level.

This object is achieved according to the present disclosure.

In the context of the present disclosure, a stator is understood to be a stator concept for an electric motor of the internal rotor construction type, or an electric motor of the external rotor construction type.

In the context of the present disclosure, components of the stator can be produced by means of punch-bundling methods and/or additive methods. To this end, dynamo sheets can in particular be baked by means of baking varnish methods and/or adhesively bonded by means of Glulock methods.

In the context of the present disclosure, able to be combined in a modular manner is understood to be a construction kit principle in which the corresponding components are combined so as to form a stator.

Furthermore, in the context of the present disclosure, an electric winding can be wound from wire, cast or moulded from a solid material.

Furthermore, in the context of the present disclosure, a cooling means can be understood to be, for example, heat pipes adapted in a U-shaped manner, or heat conduction pipes, or water cooling, for example.

The stator according to the present disclosure for an electric motor comprises the following components: at least one first basic stator, wherein the basic stator is formed from at least two basic stator modules which in an annular manner are disposed in series, wherein the first basic stator module conjointly with the at least second basic stator module forms a stator yoke, wherein each of the basic stator modules configures a stator tooth that extends radially from the stator yoke; at least one tooth shoe, wherein the tooth shoe is connected to the stator tooth in a force-fitting and form-fitting manner by means of a tongue-and-groove connection, in particular by means of a dovetail joint; at least one electric winding; at least one insulation which electrically isolates the basic stator from the winding (9), as well as at least one expansion means, characterized in that the components basic stator, tooth shoe, electric winding and expansion means are able to be combined with one another in a modular manner.

As a result of the possibility to freely design the components of the stator, a flexible adaptation of the stator geometry which can be utilized, for example, with regard to the magnetic flux, the noise generation or the vibration behaviour of the stator, can be achieved. The stator teeth can be wound with a winding separately and/or in a freely accessible manner, and the filling level of the stator groove that extends within two tooth shoes can be optimized. The winding can thus be carried out swiftly by means of automated methods such as, for example, the flyer winding methods. An oblique feature of the winding to enable the attachment to the stator teeth can thus be dispensed with or at least minimized.

Furthermore, the parameter of the groove opening in the context of the radial mutual spacing of the edges of the tooth shoes can be freely chosen. This, by virtue of the proximity of the groove opening to the air gap between the stator and the rotor of an electric motor, enables an improvement in the behaviour of the stator in terms of noise and vibrations. A modularity of the components of this type can additionally be utilized for rapidly adapting the stator as required during production, because individual components can be flexibly manufactured, and contour adaptations can be rapidly and easily implemented during production.

The latching moment and the pole sensitivity of the electric motor can be reduced to a minor value, and additional adaptations for removing undesirable radial forces can be performed if required.

Additionally, the individual components can be produced independently of one another and by means of different methods, this potentially increasing the flexibility during manufacturing, for example when using additive manufacturing methods.

Furthermore, a possibility of attaching cooling devices in the stator groove in a simplified manner is achieved, because the stator groove is freely accessible during the production process and until the tooth shoes are attached.

It is furthermore provided that the stator comprises at least one cooling device.

As a result, an optimal discharge of heat can be guaranteed during the operation of the stator.

It is furthermore provided that the first basic stator conjointly with at least one second basic stator forms a basic stator group.

As a result, arbitrary construction lengths of the stator can be achieved in a flexible manner and by means of combining a plurality of prefabricated basic stators. It is thus possible to implement a production of construction lengths which cannot be accomplished by means of usual methods of punch bundling.

In one embodiment it is provided that the basic stators are mutually axially aligned and connected by means of bundle joins.

Simple mutual aligning of the basic stators and rapid assembling can be made possible as a result. For example, corresponding joining domes for interconnecting the stator by means of an interconnection ring can be utilized, this being able to be carried out in an automated manner, for instance by means of insulation displacement techniques in conjunction with stamping and bending techniques. This can have a positive effect on the quality of interconnection as well as on the production time of the stator.

A design embodiment in which the tooth shoe is configured in multiple parts, for example in the axial direction, in particular from a first tooth shoe segment and at least one second tooth shoe segment, is furthermore advantageous.

In a manner analogous to construction lengths of the prefabricated basic stators, correspondingly prefabricated tooth shoe segments can thus be used in the production of the stator, this potentially enabling rapid and flexible assembling of the stator.

It is furthermore provided that a tongue of the tongue-and-groove connection, in particular of the dovetail joint, is configured so as to be split in two.

As a result, an elasticity in the connection between the tooth shoe and the stator tooth can be enabled, this having an advantageous effect in terms of avoiding undesirable vibrations as well as the generation of noise associated therewith. Moreover, tolerances of the tooth shoe, which has been additively manufactured, for example, and/or of the stator tooth can be compensated across axially large construction lengths of the stator, and simple assembling of the stator can be made possible.

It is furthermore preferable for the tongue-and-groove connection, in particular the dovetail joint, by means of the expansion means, in particular a bolt, preferably a flat key, configures a force-fit between the stator tooth and the tooth shoe.

As a result, bracing of the connection between the stator tooth and the tooth shoe can be made possible, this potentially having an advantageous effect on the stability and the dimensional stiffness, on the one hand, as well as on the vibration behaviour and on the noise behaviour of the stator associated therewith, on the other hand. For example, the properties of the connection between the tooth shoe and the stator tooth can be configured by means of simply adapting the expansion means.

In one advantageous embodiment it is provided that the insulation is configured as a winding member for receiving the winding, wherein the winding member is in particular configured so as to be dimensionally stable in relation to wire tensions of the winding.

The winding member can thus be utilized for separate winding, and for subsequently fitting the winding to the basic stator or the basic stator group. The winding can be separately prefabricated, for example by means of automated and cost-effective flyer winding, and pre-tailored for different construction lengths of the stator. Additional assembly costs such as, for example, the otherwise required additional insulation of the stator in relation to the winding can be prevented. Additional and insulating end discs, or overmoulding of the entire stator, can be dispensed with as a result.

Furthermore, the winding member can prevent damage arising in the course of attaching the winding to the tooth shoe, for instance by virtue of existing sheet-metal edges. By means of manufacturing the winding member from plastics materials, for example, said winding member can be adapted in a simple and flexible manner to different requirements during production. Additional windings, for example by virtue of large construction lengths, can be dispensed with as a result.

It is furthermore provided that the winding member has an interconnection region for receiving a winding wire start and/or a winding wire end.

It is advantageous here that a start and/or an end of the winding wire can be reliably deposited at the location of the interconnection, for example by means of insulation displacement pockets or insulation displacement techniques. Upon completion of the stator, insulation displacement pockets of this type can then be interconnected in a pluggable manner, for example by means of further interconnection discs or interconnection rings. As a result, an automatic winder used for the winding can deposit and sever the winding wire start and the winding wire end in the interconnection region, as a result of which said winding wire start and winding wire end do not lie exposed, this preventing the winding being released. This can save time and costs during production.

It is furthermore provided that the stator yoke between each of the stator teeth has in each case one yoke groove which for receiving the cooling device points in the axial direction of the stator.

Simple assembling of the cooling device can be made possible as a result, and potential disturbances of the magnetic flux by virtue of the assembled cooling device can be minimized.

A design embodiment in which the cooling device encloses the stator teeth (6) in a meandering manner, so as to follow an up-and-down movement when viewed in the radial direction onto the stator, is furthermore advantageous.

As a result, simple and rapid contacting of the cooling device upon assembling the stator can be made possible, and a tight contact between the cooling device and the stator can be achieved for effective cooling.

Furthermore, the present disclosure describes a method for producing a stator according to one of the preceding claims, said method comprising the following steps:
a. providing at least one first basic stator;
b. providing at least one second basic stator;
c. axially aligning the basic stators in relation to one another and mechanically connecting the basic stators so as to form a basic stator group;
d. fitting a cooling device in a yoke groove of the basic stator group;
e. providing a cast, moulded and/or wound electric winding on a winding member;
f. fitting the winding member to the basic stator group;
g. providing at least one first tooth shoe segment;
h. providing at least one second tooth shoe segment;
i. connecting the tooth shoe segments to the basic stator group by means of a tongue-and-groove connection, in particular by means of a dovetail joint;
j. fitting an expansion means in the axial direction of the stator within the tongue-and-groove connection, in particular within the dovetail joint;
k. contacting the electric winding and/or the cooling device.

Further details of the present disclosure will be described in the drawings by means of schematically illustrated exemplary embodiments.

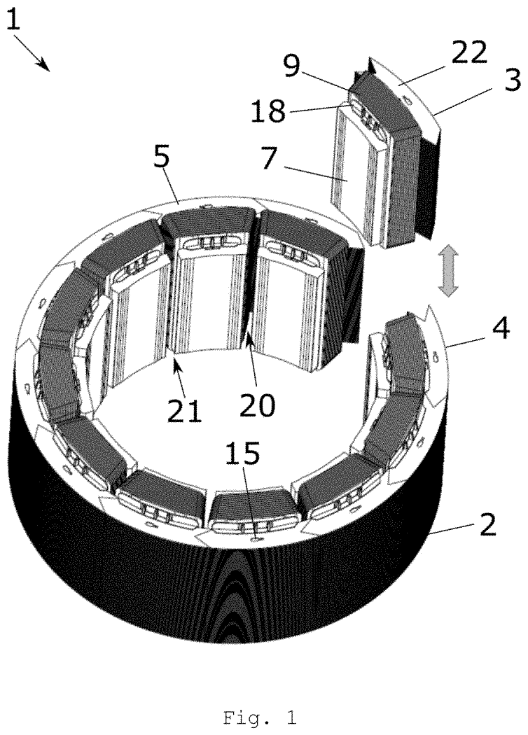

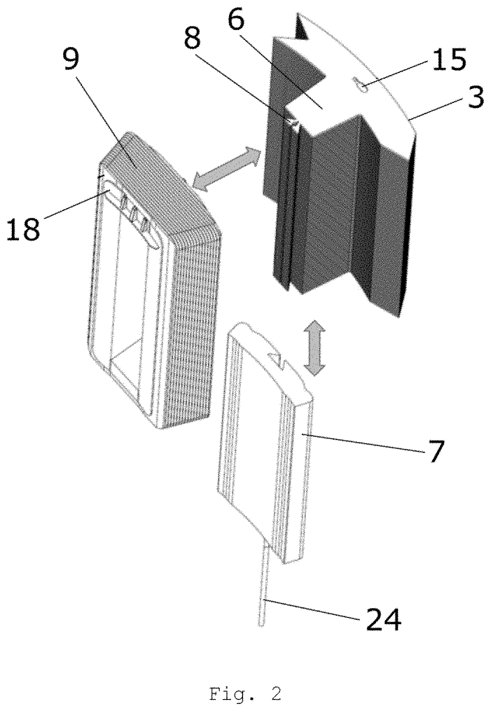

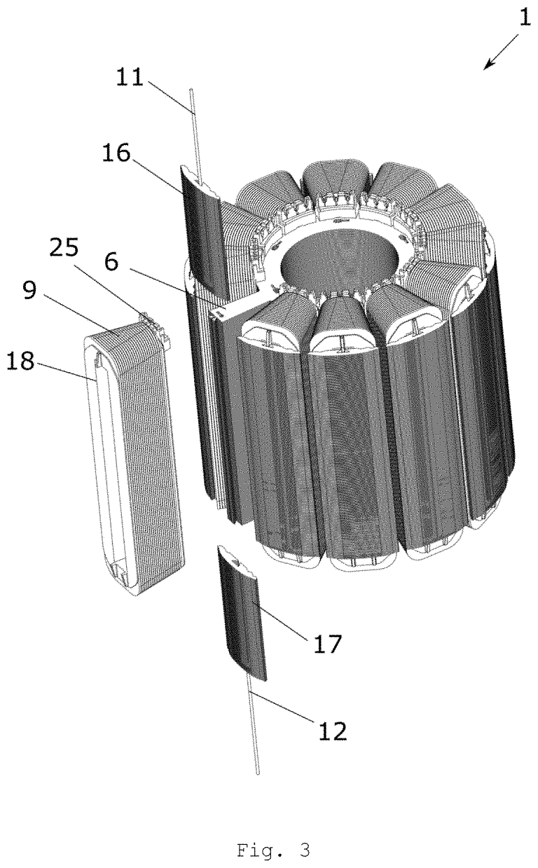

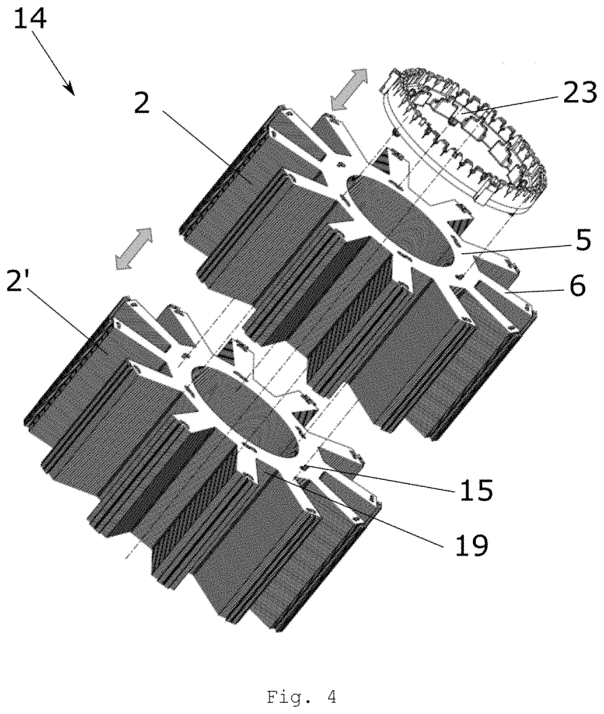

The present disclosure will be described in more detail hereunder using examples for a stator 1 of an internal rotor electric motor illustrated in FIGS. 1 and 2, as well as for a stator 1 of an external rotor electric motor illustrated in FIGS. 3 to 5, identical reference signs indicating identical structural and/or functional features. Furthermore, a perspective exploded view of a stator 1 in a pre-assembly state is shown in each case in FIG. 1 and FIG. 3. The interconnection ring illustrated in FIG. 4 can likewise be implemented in an analogous manner for an internal rotor electric motor, this not being explicitly illustrated for reasons of clarity.

The stator 1 comprises a basic stator 2, wherein the basic stator 2 is formed from 12 basic stator modules 3, 4 which in an annular manner are disposed in series and engage in one another. A high level of stability of the basic stator 2 can be made possible by means of a connection between the basic stator modules 3, 4 that is configured as a form-fit, for example. The basic stator modules 3, 4 form a common stator yoke 5 of the basic stator 2, wherein each one of the basic stator modules 3, 4 configures a stator tooth that extends radially from the stator yoke 5.

In the case of the stator 1 for an internal rotor electric motor shown in FIG. 1, the stator teeth 6 extend radially inward, and in the case of the stator 1 for an external rotor electric motor shown in FIG. 2, said stator teeth 6 extend radially outward.

By way of example it is illustrated that the basic stator modules 3, 4 are in each case manufactured from a multiplicity of dynamo sheets 22. It is provided that the individual components of the stator 1 can also be provided by means of additive manufacturing methods as is illustrated, for instance, on a tooth shoe 7 shown in FIG. 1. A high level of flexibility and manufacturing which is cost-effective and adapted to the respective requirements of production can thus be made possible. As a result, special requirements in terms of the geometric design of the tooth shoes 7 can be taken into account and implemented rapidly.

The tooth shoes 7 are connected in a force-fitting and/or form-fitting manner to the stator teeth 6 by means of a dovetail joint 8, this potentially having an advantageous effect in terms of the distribution of the forces that arise in the operation of the stator 1. It is illustrated in FIG. 3 that the tooth shoes 7 in the axial direction are configured in multiple parts, in each case from a first tooth shoe segment 16 and in each case one second tooth shoe segment 17, and the respective dovetail joints 8 are in each case braced in a force-fitting and form-fitting manner by means of expansion means 11, 12 configured as bolts 24. It is furthermore shown in FIG. 3 that the tooth shoes 7, or the tooth shoe segments 16, 17, respectively, are produced from dynamo sheets 22. The tongue (not provided with a reference sign) of the dovetail joint 8 is configured in two parts, as is illustrated in FIG. 2, for example, as a result of which manufacturing tolerances of the corresponding components can be compensated for when joining the components. Moreover generated is an elasticity of the connection that is adjustable as a function of the chosen expansion means and can have a positive effect on the vibration properties of the stator 1, making it possible for the noise generation to be minimized.

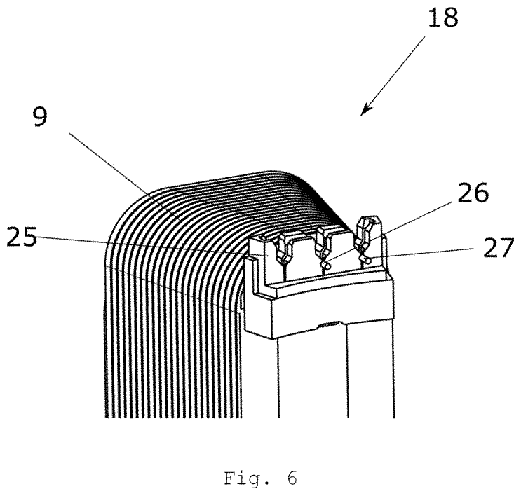

It is furthermore illustrated that the interconnection of the windings is enabled for example by means of an interconnection ring 23, as is illustrated in an exemplary manner in FIG. 4, or by means of interconnection regions 25 attached to the winding members 18, such as illustrated in FIG. 3. In the case of an interconnection by means of interconnection regions 25, the simple contacting of the windings is advantageously, as is that a winding wire start 26 and/or a winding wire end 27 can be deposited directly and reliably at the location of the interconnection, for example by means of insulation displacement pockets or insulation displacement techniques, as is illustrated in FIG. 6. Upon the completion of the stator, the winding wire start 26 and the winding wire end can be interconnected in a pluggable manner by means of further interconnection discs or further interconnection rings as a result.

Illustrated in FIG. 4 is a perspective view of a first basic stator 2 and of a second basic stator 2′ in a pre-assembly state for producing a basic stator group 14 to be wound. The basic stators 2, 2′, so as to be axially aligned with one another, are connected at the end sides by means of bundle joins 15 and by way of an interconnection ring 23. Different construction lengths of the stator 1 can thus be easily implemented by means of prefabricated basic stators 2, 2′. It is additionally illustrated in FIG. 4 that the stator groove 20 in this assembled state is freely accessible and a winding 9 can be incorporated in a swift and cost-saving manner in the stator groove 20 on the stator tooth 6, for example by means of a flyer winding technique.

It is furthermore illustrated that the stator teeth 6 are electrically isolated from a respective winding 9 by means of a winding member 18 configured for receiving the respective winding 9. A dimensional stability of the winding member 18 in terms of wire tensions makes it possible for the winding member 18 to be separately wound. As a result, the winding can be pre-fabricated in a cost-effective manner, independently of the basic stator 2. By virtue of the modularity of the stator 1, this winding can then be fitted to a stator tooth 6. Potential obstacles in the fitting process, for example by virtue of the mutual geometry of the tooth shoes 7, the stator teeth 6 and the stator yoke 5, can be circumvented as a result and optimal winding of the stator 1 be made possible.

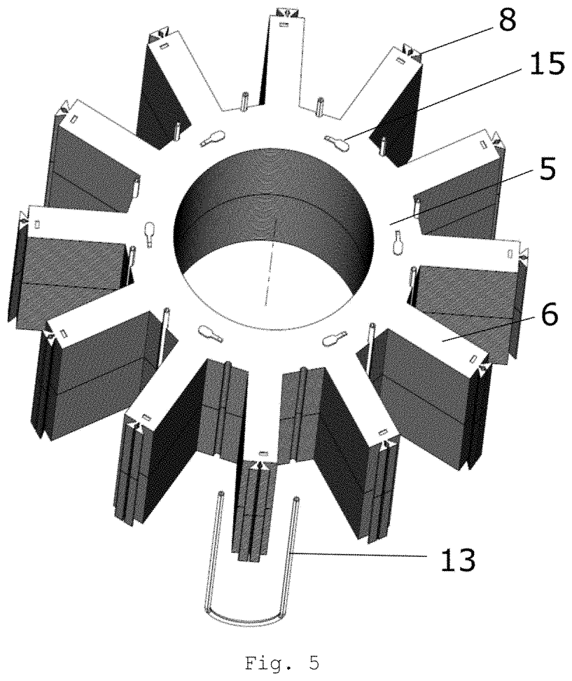

A basic stator 2 in a pre-assembly state is illustrated in a perspective view in FIG. 5. The stator yoke 5 between each one of the stator teeth 6 has in each case a yoke groove 19 which points in the axial direction of the stator 1 and is configured for receiving a cooling device 13. The cooling device 13 in FIG. 5 is illustrated as a sectional illustration and, in an axial view onto the stator 1, follows a meandering up-and-down movement in that said cooling device 13 encloses the stator teeth 6. As a result, simple and flexible contacting of the cooling device 13 can be enabled. The cooling device bears tightly between the stator yoke 5 and the stator teeth 6, and can be utilized for effective cooling of the stator 1. Potential disturbances of the magnetic flux by the cooling device 13 can be minimized as a result.

Although the present invention has been described with reference to preferred embodiments, workers skilled in the art will recognize that changes may be made in form and detail without departing from the spirit and scope of the invention.

### LIST OF REFERENCE SIGNS

1 Stator
2, 2′ Basic stator
3 First basic stator module
4 Second basic stator module
5 Stator yoke
6 Stator tooth
7 Tooth shoe
8 Dovetail joint
9 Winding
11 First expansion means
12 Second expansion means
13 Cooling device
14 Basic stator group
15 Bundle join
16 First tooth shoe segment
17 Second tooth shoe segment
18 Winding member
19 Yoke groove
20 Stator groove
21 Stator groove opening
22 Dynamo sheet
23 Interconnection ring
24 Bolt
25 Interconnection region
26 Winding wire start
27 Winding wire end

What is claimed is:

1. A stator for an electric motor, the stator comprising:
at least one first basic stator,
wherein the at least one first basic stator is formed from at least two basic stator modules which in an annular manner are disposed in series,
wherein the first basic stator module conjointly with the at least second basic stator module forms a stator yoke,
wherein each of the basic stator modules configures a stator tooth that extends radially from the stator yoke;
at least one tooth shoe,
wherein the at least one tooth shoe is connected to the stator tooth in a force-fitting and/or form-fitting manner by a tongue-and-groove connection;
at least one electric winding;
at least one insulation which electrically isolates the at least one first basic stator from the at least one electric winding, and
at least one expansion means,
wherein
the at least one first basic stator, the at least one tooth shoe, the at least one electric winding, and the at least one expansion means are able to be combined with one another in a modular manner.

2. The stator of claim 1, wherein the tongue-and-groove connection comprises a dovetail joint.

3. The stator of claim 1, further comprising at least one cooling device.

4. The stator of claim 1, wherein the at least one first basic stator, conjointly with at least one second basic stator, forms a basic stator group.

5. The stator of claim 1, wherein the basic stators are mutually axially aligned and connected by bundle joins.

6. The stator of claim 1, wherein the tooth shoe is configured in multiple parts.

7. The stator of claim 6, wherein the tooth shoe, in the axial direction, is configured from a first tooth shoe segment and at least one second tooth shoe segment.

8. The stator of claim 1, wherein a tongue of the tongue-and-groove connection is configured so as to be split in two.

9. The stator of claim 1, wherein the tongue-and-groove connection, by means the expansion means, configures a force-fit between the stator tooth and the tooth shoe.

10. The stator of claim 9, the expansion means comprises a bolt.

11. The stator of claim 10, wherein the bolt comprises a flat key.

12. The stator of claim 1, wherein the insulation is configured as a winding member for receiving the winding, wherein the winding member is in particular configured so as to be dimensionally stable in relation to wire tensions of the winding.

13. The stator of claim 1, wherein the winding member has an interconnection region for receiving a winding wire start and/or a winding wire end.

14. The stator of claim 1, wherein the stator yoke between each of the stator teeth has in each case one yoke groove which for receiving the cooling device points in the axial direction of the stator.

15. The stator of claim 1, wherein the cooling device encloses the stator teeth in a meandering manner, so as to follow an up-and-down movement when viewed in the radial direction onto the stator.

16. A method for producing a stator, the method comprising:
a. providing at least one first basic stator;
b. providing at least one second basic stator;
c. axially aligning the basic stators in relation to one another and mechanically connecting the basic stators so as to form a basic stator group;
d. fitting a cooling device in a yoke groove of the basic stator group;
e. providing a cast and/or wound electric winding on a winding member;
f. fitting the winding member to the basic stator group;
g. providing at least one first tooth shoe segment;
h. providing at least one second tooth shoe segment;
i. connecting the tooth shoe segments to the basic stator group by a tongue-and-groove connection;
j. fitting an expansion means in the axial direction of the stator within the tongue-and-groove connection; and
k. contacting the electric winding and/or the cooling device.

17. The method of claim 16, wherein the tongue-and-groove connection comprises a dovetail joint.
